(19) United States
(12) Patent Application Publication
(10) Pub. No.: US 2005/0153865 A1
(43) Pub. Date: Jul. 14, 2005

(54) Cationically modified, anionic polyurethane dispersions

(76) Inventors: Jürgen Detering, Limburgerhof (DE); Karl Haberle, Speyer (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/508,843

(22) PCT Filed: Apr. 7, 2003
(86) PCT No.: PCT/EP03/03604

(30) Foreign Application Priority Data
Apr. 9, 2002 (DE) 102 15 522.4

(51) Int. Cl. C11D 3/37

(52) U.S. Cl. 510/475

(57) ABSTRACT

The invention describes cationically modified particulate anionic polyurethanes having a particle size from 10 nm to 10 μm, the particulate polyurethanes being cationically modified through surface coating with cationic polymers. Preferred cationic polymers are polymers containing vinylamine units, polymers containing vinylimidazole units, polymers containing quaternary vinylimidazole units, condensates of imidazole and epichlorohydrin, crosslinked polyamidoamines, ethyleneimine-grafted crosslinked polyamidoamines, polyethyleneimines, alkoxylated polyethyleneimines, crosslinked polyethyleneimines, amidated polyethyleneimines, alkylated polyethyleneimines, polyamines, amine-epichlorohydrin polycondensates, alkoxylated polyamines, polyallylamines, polydimethyldiallylammonium chlorides, polymers containing basic (meth)acrylamide or (meth)acrylic ester units, polymers containing basic quaternary (meth)acrylamide or (meth)acrylic ester units, and/or lysine condensates.

The present invention relates to cationically modified particulate anionic polyurethanes, aqueous polyurethane dispersions containing same, the use of the particulate polyurethanes and of the polyurethane dispersions, processes for treating surfaces and treatment compositions therefor which contain the cationically modified particulate anionic polyurethanes.

Anionic polyurethane dispersions are used in industry for modifying the properties of surfaces. For example, aqueous anionic polyurethane dispersions are used in concentrated form for finishing and coating textiles and textile substrates and in leather finishing. The dispersions are applied to a substrate by common methods, for example knifecoating, brushing, saturating or impregnating, and then dried. In the process, the finely divided particles form a film and confer novel properties on the surface to which they have been applied.

Washing, rinsing, cleaning and conditioning operations are by contrast customarily carried out in a very dilute aqueous liquor, and the ingredients of the particular formulation employed do not remain on the substrate, but instead are disposed of with the wastewater. Modification of surfaces with anionic polyurethane dispersions from a dilute aqueous liquor is achieved only to an entirely unsatisfactory degree owing to the insufficient surface affinity of the polyurethane particles.

U.S. Pat. No. 3,580,853 describes a detergent composition containing water-insoluble particulate substances such as biocides and certain cationic polymers which serve to enhance the deposition and retention of the biocides on surfaces washed with the detergent composition.

U.S. Pat. No. 5,476,660 discloses using polymeric retention aids for cationic or zwitterionic dispersions of polystyrene or wax which contain an active substance embedded in the dispersed particles. These dispersed particles are referred to as “carrier particles” because they adhere to the treated surface, where they release the active substance, for example when used in surfactant-containing formulations.

WO 01/94516 describes the use of cationically modified particulate hydrophobic polymers based on ethylenically unsaturated monomers in rinsing or conditioning compositions for textiles and in laundry detergents. The particulate hydrophobic polymers are preferably constructed of water-insoluble nonionic monomers such as alkyl acrylates. The cationic modification is effected by coating the hydrophobic polymer particles with cationic polymers.

WO 01/94517 describes the use of cationically modified particulate hydrophobic polymers based on ethylenically unsaturated monomers in rinsing, cleaning and impregnating compositions for hard surfaces.

It is an object of the present invention to provide treatment compositions for textile and nontextile materials that can be used even in a very dilute aqueous liquor and that confer advantageous properties on the surfaces of the treated materials or the materials themselves.

We have found that this object is achieved by cationically modified particulate anionic polyurethanes having a particle size from 10 nm to 10 μm, the particulate polyurethanes being cationically modified through surface coating with cationic polymers, and also by cationically modified aqueous anionic polyurethane dispersions which include said cationically modified particulate anionic polyurethanes.

The present invention further provides for the use of the cationically modified particulate anionic polyurethanes as a surface-modifying additive in washing, rinsing, conditioning or cleaning compositions.

The present invention further provides for the use of the cationically modified aqueous anionic polyurethane dispersions as a rinsing, washing or cleaning liquor.

The particulate polyurethanes which are cationically modified through surface coating contain anionic groups. They may additionally contain cationic groups as well, provided the particles have a net anionic charge overall. The net anionic charge causes the polyurethane particles to migrate to the anode in an electric field at a given pH. Thus, not only purely anionic but also amphoteric polyurethane dispersions can be cationically modified, as long as the anionc character of the polyurethane dispersions predominates, ie the molar fraction of the anionic units in the polymer is larger than the molar fraction of the cationic units in the polymer. Such polyurethane dispersions of predominantly anionic character are hereinafter referred to as anionic polyurethane dispersions. Coating the particle surface of the anionic polyurethane particles with cationic polymers renders these anionic polyurethane particles cationic, so that the particles have a net cationic charge on the surface and their direction of migration in an electric field reverses.

The cationically surface-modified particulate polyurethanes are obtainable for example by treatment of aqueous anionic polyurethane dispersions comprising polyurethane particles from 10 mm to 10 μm in size with an aqueous solution or dispersion of a cationic polymer. This is accomplished most simply by combining the aqueous anionic polyurethane dispersion which contains particles from 10 nm to 10 μm in particle size with the aqueous solution or dispersion of the cationic polymer. The cationic polymers are preferably used in the form of aqueous solutions. However, it is also possible to use aqueous dispersions of cationic polymers, in which case the cationic polymer particles dispersed therein have an average diameter of up to 1 μm.

The mixing of the aqueous anionic polyurethane dispersion and of the solution or dispersion of the cationic polymers can be effected at for example 0-100° C. The amount of cationic polymers which is needed to effect cationic modification is dependent not only on the net surface charge of the polyurethane particles but also on the charge density of the cationic polymers at the pH prevailing during the coating of the polyurethane particles with the cationic polymers. The weight ratio of dispersed polyurethane particles to cationic polymers is generally in the range from 100:0.5 to 100:5.

Surprisingly, the presence of the cationic polymers does not induce a coagulation of the oppositely charged anionic dispersion particles, rather the dispersions of the cationically modified particles obtained are stable.

Cationic modification enhances the affinity of the anionic polyurethane particles for the surface to be treated, for example the surface of a textile fiber, to such an extent that the polyurethane particles will readily absorb onto the surface from very dilute aqueous treatment liquors, while it preserves the desirable film-forming, surface-modifying properties of the anionic polyurethane particles.

A Aqueous Polyurethane Dispersions

The aqueous anionic polyurethane dispersions are conveniently prepared by reacting
a) polyisocyanates having from 4 to 30 carbon atoms,
b) diols of which
b1) from 10 to 100 mol %, based on total diols (b), have a molecular weight from 500 to 5000, and
   b2) from 0 to 90 mol %, based on total diols (b), have a molecular weight from 62 to 500 g/mol,
c) optionally further polyfunctional compounds, other than said diols (b), having reactive groups selected from alcoholic hydroxyl groups and primary or secondary amino groups, and
d) monomers, other than said monomers (a), (b) and (c), which bear at least one isocyanate group or at least one isocyanate-reactive group and which in addition bear at least one hydrophilic group I or a potentially hydrophilic group whereby the polyurethanes are rendered dispersible in water,
   to form a polyurethane.

Useful monomers (a) include the polyisocyanates customarily used in polyurethane chemistry.

Of particular interest are diisocyanates X(NCO)₂, where X is aliphatic hydrocarbyl having from 4 to 12 carbon atoms, cycloaliphatic or aromatic hydrocarbyl having from 6 to 15 carbon atoms or araliphatic hydrocarbyl having from 7 to 15 carbon atoms. Examples of such diisocyanates are tetramethylene diisocyanate, hexamethylene diisocyanate, dodecamethylene diisocyanate, 1,4-diisocyanatocycohexane, 1-isocyanato-3,5,5-trimethyl-5-isocyanatomethylcyclohexane (IPDI), 2,2-bis-(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4-diisocyantodiphenylmethane, p-xylylene diisocyanate, m- and p-α,α,α′,α′-tetramethylxylylene diisocyanate (TMXDI), the isomers of bis-(4-isocyanatocyclohexyl)methane such as the trans/trans, the cis/cis and the cis/trans isomers, and also mixtures thereof.

Useful mixtures of these isocyanates include particularly the mixtures of the respective structural isomers of diisocyanatotoluene and diisocyanatodiphenylmethane, especially the mixture of 20 mol % of 2,4-diisocyanatotoluene and 80 mol % of 2,6-diisocyanatotoluene. Furthermore, the mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, the preferred mixing ratio of aliphatic to aromatic isocyanates being in the range from 4:1 to 1:4.

As compounds (a) it is further possible to use isocyanates which, as well as free isocyanate groups, bear capped isocyanate groups, for example uretidione or urethane groups.

It is optionally possible to use in addition isocyanates having only one isocyanate group. Generally, their fraction is not more than 10 mol %, based on total monomers. The monoisocyanates customarily bear further functional groups such as olefinic groups or carbonyl groups and serve to introduce into the polyurethane functional groups effective to permit dispersion or crosslinking or further polymer-analogous reaction of the polyurethane. Monoisocyanates contemplated for the purpose include monomers such as isopropenyl α,α-dimethylbenzylisocyanate (TMI).

To prepare polyurethanes having a certain degree of branching or crosslinking, it is possible to use for example trifunctional or tetrafunctional isocyanates. Isocyanates of this type are obtained for example on reacting difunctional isocyanates with each other by derivatizing some of their isocyanate groups to allophanate or isocyanurate groups. Commercially available compounds include for example the isocyanurate of hexamethylene diisocyanate.

With regard to good filming and elasticity, useful diols (b) include primarily comparatively high molecular diols (b1) having a molecular weight of about 500-5000 and preferably of about 1000-3000 g/mol.

The diols (b1) are especially polyesterpolyols, which are known for example from Ullmanns Enzyklopädie der technischen Chemie, 4th edition, Volume 19, pages 62 to 65. Preference is given to using polyesterpolyols which are obtained by reaction of dihydric alcohols with dibasic carboxylic acids. Instead of the free polycarboxylic acids it is also possible to use the corresponding polycarboxylic anhydrides or corresponding polycarboxylic esters of lower alcohols or mixtures thereof for preparing the polyesterpolyols. The polycarboxylic acids can be aliphatic, cycloaliphatic, araliphatic, aromatic or heterocyclic and can be unsaturated and/or substituted, for example by halogen atoms. Examples are suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids. Preference is given to dicarboxylic acids of the general formula HOOC—(CH₂)_{y}—COOH, where y is from 1 to 20, preferably an even number from 2 to 20, e.g., succinic acid, adipic acid, dodecanedicarboxylic acid and sebacic acid.

Suitable polyhydric alcohols include, for example, ethylene glycol, 1,2-propanediol, 1,3-propanediol, 1,3-butanediol, 1,4-butenediol, 1,4-butynediol, 1,5-pentanediol, neopentylglycol, bis(hydroxymethyl)cyclohexanes such as 1,4-bis(hydroxymethyl)cyclohexane, 2-methylpropane-1,3-diol, also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH2)ₓ—OH, where x is from 1 to 20, preferably an even number from 2 to 20. Examples thereof are ethylene glycol, 1,4-butanediol, 1,6-hexanediol, 1,8-octanediol and 1,12-dodecanediol.

Also suitable are polycarbonatediols as are obtainable, for example, by reaction of phosgene with an excess of the low molecular weight alcohols mentioned as formative components for the polyesterpolyols.

It is also possible to use lactone-based polyesterdiols, ie, homo- or copolymers of lactones, preferably terminal hydroxyl-functional addition products of lactones on suitable difunctional initiator molecules. Preferred lactones are derived from hydroxycarboxylic acids, of the general formula HO—(CH₂)_{z}—COOH, where z is from 1 to 20, preferably an odd number from 3 to 19, e.g. ε-caprolactone, β-propiolactone, γ-butyrolactone and/or methyl-ε-caprolactone and also mixtures thereof. Suitable initiator components include, for example, the low molecular weight dihydric alcohols mentioned above as formative components for the polyesterpolyols. The corresponding addition polymers of ε-caprolactone are particularly preferred. Similarly, lower polyesterdiols or polyetherdiols can be used as initiators for preparing the lactone addition polymers. Instead of the addition polymers of lactones it is also possible to use the corresponding, chemically equivalent polycondensates of the hydroxycarboxylic acids corresponding to the lactones.

Useful monomers (b1) further include polyetherdiols. They are obtainable in particular by homopolymerization of ethylene oxide, propylene oxide, butylene oxide, tetrahydrofuran, styrene oxide or epichlorohydrin, for example in the presence of BF₃, or by the addition of these compounds, optionally mixed or in succession, to initiating components having reactive hydrogen atoms, such as alcohols or amines, e.g., water, ethylene glycol, 1,2-propanediol, 1,3-propanediol, 2,2-bis(4-hydroxydiphenyl)propane or aniline. Particular preference is given to polytetrahydrofuran having a molecular weight of from 2 000 to 5000, especially from 3 500 to 4500.

The polyesterdiols and polyetherdiols may be used as mixtures in a ratio in the range from 0.1:1 to 9:1.

The hardness and the modulus of elasticity of the polyurethanes can be increased by using as diols (b) not only diols (b1) but additionally low molecular weight diols (b2) having a molecular weight of from about 50 to 500, preferably from 60 to 200, g/mol.

Useful monomers (b2) include especially the formative components for the short chain alkanediols mentioned for preparing polyesterpolyols, preference being given to the unbranched diols having from 2 to 12 carbon atoms and an even number of carbon atoms and also to 1,5-pentanediol and neopentylglycol.

The proportion of diols (b1), based on total diols (b), is preferably from 10 to 100 mol % and the proportion of monomers (b2), based on total diols (b), is preferably from 0 to 90 mol %. The ratio of diols (b1) to monomers (b2) is particularly preferably within the range from 0.2:1 to 5:1, particularly preferably within the range from 0.5:1 to 2:1.

The monomers (c), which differ from the diols (b), generally serve the purpose of crosslinking or of chain extension. They are generally more than dihydric nonaromatic alcohols, amines having 2 or more primary and/or secondary amino groups and also compounds which bear one or more primary and/or secondary amino groups alongside one or more alcoholic hydroxyl groups.

Alcohols having a hydricness higher than 2, which can be used to set a certain degree of branching or crosslinking, are, for example, trimethylolpropane, glycerol or sugars.

It is also possible to use monoalcohols which, as well as the hydroxyl group, bear a further isocyanate-reactive group such as monoalcohols having one or more primary and/or secondary amino groups, e.g., monoethanolamine.

Polyamines having 2 or more primary and/or secondary amino groups are used in particular when the chain extension or crosslinking is to take place in the presence of water, since amines generally react faster with isocyanates than alcohols or water. This is frequently necessary when aqueous dispersions of crosslinked polyurethanes or polyurethanes having a high molecular weight are desired. In such cases, prepolymers with isocyanate groups are prepared, rapidly dispersed in water and subsequently chain extended or crosslinked by addition of compounds having a plurality of isocyanate-reactive amino groups.

Suitable amines for this purpose are generally polyfunctional amines of the molecular weight range from 32 to 500 g/mol, preferably from 60 to 300 g/mol, which contain at least two amino groups selected from the group of the primary and secondary amino groups. Examples thereof are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, for example in the form of the corresponding ketimines (see for example CA-1 129 128), ketazines (cf. for example U.S. Pat. No. 4,269,7 48) or amine salts (see U.S. Pat. No. 4,292,226). Similarly, oxazolidines as used in U.S. Pat. No. 4,192,937, for example, are capped polyamines which can be used to chain extend the prepolymers in the preparation of the polyurethanes of the present invention. When such capped polyamines are used, they are generally mixed with the prepolymers in the absence of water and this mixture is subsequently mixed with the dispersion water or a portion of the dispersion water, so that the corresponding polyamines are released hydrolytically.

Preference is given to using mixtures of di- and triamines, particularly preferably mixtures of isophoronediamine and diethylenetriamine.

The polyurethanes preferably contain no polyamine or from 1 to 10, particularly preferably from 4 to 8, mol %, based on the total amount of components (b) and (c), of a polyamine having at least 2 isocyanate-reactive amino groups as monomer (c).

It is further possible to use, for chain termination, minor amounts, ie preferably amounts of less than 10 mol %, based on the components (b) and (c), of monoalcohols. Their function is generally similar to that of the monoisocyanates, ie they mainly serve to functionalize the polyurethane. Examples are esters of acrylic or methacrylic acid such as hydroxyethyl acrylate or hydroxyethyl methacrylate.

To render the polyurethanes water dispersible, they are polymerized not only from the components (a), (b) and (c) but also monomers (d) which differ from components (a), (b) and (c) and which bear one or more isocyanate or isocyanate-reactive groups and additionally at least one hydrophilic group or a group which is convertible into a hydrophilic group. In what follows, the expression “hydrophilic groups or potentially hydrophilic groups” is abbreviated to “(potentially) hydrophilic groups”. The (potentially) hydrophilic groups react significantly more slowly with isocyanates than the functional groups of the monomers which serve to polymerize the polymer backbone. The (potentially) hydrophilic groups may be nonionic or preferably ionic hydrophilic groups or potentially ionic hydrophilic groups.

The proportion of the total amount of components (a), (b), (c) and (d) which is attributable to components having (potentially) hydrophilic groups is generally determined so that the molar amount of the (potentially) hydrophilic groups is from 30 to 1000, preferably from 50 to 500, particularly preferably from 80 to 300, mmol/kg, based on the weight of all monomers (a) to (b).

Suitable nonionic hydrophilic groups include in particular polyethylene glycol ethers containing preferably from 5 to 100, preferably from 10 to 80, ethylene oxide repeat units. >The level of polyethylene oxide units is generally within the range from 0 to 10, preferably from 0 to 6,% by weight, based on the weight of all monomers (a) to (d).

Preferred monomers with nonionic hydrophilic groups are polyethylene glycol and diisocyanates which bear a terminally etherified polyethylene glycol radical. Such diisocyanates and methods for their preparation are described in U.S. Pat. Nos. 3,905,929 and 3,920,598.

Ionic hydrophilic groups include in particular anionic groups such as the sulfonate, the carboxylate and the phosphate group in the form of their alkali metal or ammonium salts and also cationic groups such as ammonium groups, especially protonated tertiary amino groups or quaternary ammonium groups.

Potentially ionic hydrophilic groups are in particular those which can be converted by simple neutralization, hydrolysis or quaternization reactions into the abovementioned ionic hydrophilic groups, e.g., carboxylic acid groups, anhydride groups or tertiary amino groups.

(Potentially) ionic monomers (d) are extensively described for example in Ullmanns Enzyklopädie der technischen Chemie, 4th edition, Volume 19, pages 311-313, and, for example, in DE-A 1 495 745.

Potentially cationic monomers (d) of particular practical importance are in particular monomers having tertiary amino groups, for example tris(hydroxyalkyl)amines, N,N′-bis(hydroxyalkyl)alkylamines, N-hydroxyalkyldialkylamines, tris-(aminoalkyl)amines, N,N′-bis(aminoalkyl)alkylamines, N-aminoalkyldialkylamines, the alkyl radicals and alkanediyl units of these tertiary amines containing from 2 to 6 carbon atoms independently of each other. Also suitable are polyethers having tertiary nitrogen atoms and preferably two terminal hydroxyl groups, as are obtainable in a conventional manner, for example, by alkoxylation of amines having two hydrogen atoms attached to amine nitrogen, e.g., methylamine, aniline or N,N′-dimethylhydrazine. Such polyethers generally have a molecular weight within the range from 500 to 6000 g/mol.

These tertiary amines are converted into the ammonium salts either with acids, preferably strong mineral acids such as phosphoric acid, sulfuric acid, or halohydric acids, or by reaction with suitable quaternizing agents such as C₁-C₆-alkyl halides, for example bromides or chlorides.

Suitable monomers with potentially anionic groups customarily include aliphatic, cycloaliphatic, araliphatic or aromatic mono- and dihydroxycarboxylic acids which bear at least one alcoholic hydroxyl group or at least one primary or secondary amino group. Preference is given to dihydroxyalkylcarboxylic acids, especially having from 3 to 10 carbon atoms, as also described in U.S. Pat. No. 3,412,054. Particular preference is given to compounds of the general formula 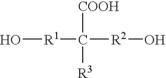
where R¹ and R² are each a C₁-C₄-alkanediyl unit and R³ is a C₁-C₄-alkyl unit, and especially dimethylolpropionic acid (DMPA).

Also suitable are the corresponding dihydroxysulfonic acids and dihydroxyphosphonic acids such as 2,3-dihydroxypropanephosphonic acid.

It is also possible to use dihydroxy compounds having a molecular weight of from above 500 to 10,000 g/mol and at least 2 carboxylate groups, known from DE-A 4 140 486. They are obtainable by reaction of dihydroxy compounds with tetracarboxylic dianhydrides such as pyromellitic dianhydride or cyclopentanetetracarboxylic dianhydride in a molar ratio of from 2:1 to 1.05:1 in a polyaddition reaction. Suitable dihydroxy compounds are in particular the monomers (b2) cited as chain extenders and also the diols (b1).

Suitable monomers (d) with isocyanate-reactive amino groups are amino acids such as lysine, β-alanine, the adducts, mentioned in DE-A-20 34 479, of aliphatic diprimary diamines with α,β-unsaturated carboxylic or sulfonic acids. Such compounds conform for example to the formula I
H₂N—R—NH—R′—X (I)
where R and R′ are independently a C₁-C₆-alkanediyl unit, preferably ethylene, and X is COOH or SO₃H. Particularly preferred compounds of the formula I are N-(2-aminoethyl)-2-aminoethanecarboxylic acid and N-(2-aminoethyl)-2-aminoethanesulfonic acid and the corresponding alkali metal salts, sodium being particularly preferred as counterion.

If monomers having potentially ionic groups are used, their conversion into the ionic form can take place before, during, but preferably after the isocyanate polyaddition reaction, since ionic monomers are frequently only sparingly soluble in the reaction mixture. The carboxylate groups are particularly preferably present in the form of their salts with an alkali metal ion or an ammonium ion as counterion.

The monomers (d) and their proportions are chosen so as to confer a net anionic character on the polyurethane dispersions obtained.

In the field of polyurethane chemistry it is common knowledge how the molecular weight of the polyurethanes can be set via the choice of the proportions of the mutually reactive monomers and via the arithmetic mean of the number of reactive functional groups per molecule.

The components (a), (b), (c) and (d) and also their respective molar quantities are normally chosen so that the ratio A:B where
A) is the molar quantity of isocyanate groups and
B) is the sum total of the molar quantity of hydroxyl groups and the molar quantity of functional groups capable of reacting with isocyanates in an addition reaction
   is within the range from 0.5:1 to 2:1, preferably within the range from 0.8:1 to 1.5, particularly preferably within the range from 0.9:1 to 1.2:1. The ratio of A:B is most preferably very close to 1:1.

As well as the components (a), (b), (c) and (d), monomers having just one reactive group are generally used in amounts of up to 15 mol % and preferably up to 8 mol %, based on the total amount of the components (a), (b), (c) and (d).

The polyaddition of the components (a) to (d) is generally effected at reaction temperatures from 20 to 180° C. and preferably from 50 to 150° C. under atmospheric pressure.

The requisite reaction times can range from a few minutes to several hours. In the field of polyurethane chemistry it is known how the reaction time is affected by a multiplicity of parameters such as temperature, concentration of the monomers, reactivity of the monomers.

The reaction of the diisocyanates can be catalyzed using customary catalysts, such as dibutyltin dilaurate, tin(II) octoate or diazabicyclo[2.2.2]octane.

A suitable apparatus for carrying out the polymerization is a stirred tank, especially when solvents are used to ensure a low viscosity and good heat removal.

If the reaction is carried out with a solvent, the usually high viscosities and the usually only short reaction times mean that typically extruders are suitable, especially selfcleaning multiscrew extruders.

The dispersions are usually prepared by one of the following processes:

In the acetone process, an anionic polyurethane is prepared from components (a) to (d) in a water-miscible solvent having an atmospheric pressure boiling point of below 100° C. Sufficient water is added to form a dispersion in which water is the coherent phase.

The prepolymer blending process differs from the acetone process in that the initial product is not a fully reacted (potentially) anionic polyurethane but a prepolymer which bears isocyanate groups. The components (a) to (d) here are chosen so that the defined A:B ratio is within the range from greater than 1.0 to 3, preferably within the range from 1.05 to 1.5. The prepolymer is first dispersed in water and then crosslinked by reaction of the isocyanate groups with amines bearing more than 2 isocyanate-reactive amino groups or chain extended with amines bearing 2 isocyanate-reactive amino groups. Chain extension takes place even when no amine is added. In this case, isocyanate groups are hydrolyzed to amino groups which react with any remaining isocyanate groups of the prepolymers to effect chain extension.

If a solvent was used in the synthesis of the polyurethane, most of it is typically removed from the dispersion, for example by distillation under reduced pressure. The dispersions preferably have a solvent content of less than 10% by weight and are particularly preferably free from solvent.

The dispersions generally have a solids content from 10 to 75, preferably from 20 to 65,% by weight and a viscosity of from 10 to 500 mPas (measured at 20° C. and a shear rate of 250 s⁻¹).

B Cationic Polymers

Useful cationic polymers for modifying the aqueous anionic polyurethane dispersions include all natural or synthetic cationic polymers which contain amino and/or ammonium groups and are soluble in water. Examples of such cationic polymers are polymers containing vinylamine units, polymers containing vinylimidazole units, polymers containing quaternary vinylimidazole units, condensates of imidazole and epichlorohydrin, crosslinked polyamidoamines, ethyleneimine-grafted crosslinked polyamidoamines, polyethyleneimines, alkoxylated polyethyleneimines, crosslinked polyethyleneimines, amidated polyethyleneimines, alkylated polyethyleneimines, polyamines, amine-epichlorohydrin polycondensates, alkoxylated polyamines, polyallylamines, polydimethyldiallylammonium chlorides, polymers containing basic (meth)acrylamide or (meth)acrylic ester units, polymers containing basic quaternary (meth)acrylamide or (meth)acrylic ester units, and/or lysine condensates.

Cationic polymers also include amphoteric polymers having a net cationic charge, ie, the polymers contain anionic as well as cationic monomers in copolymerized form, but the molar fraction of the cationic units present in the polymer is larger than that of the anionic units.

Polymers containing vinylamine units are prepared for example from open-chained N-vinylcarboxamides of the formula (I) 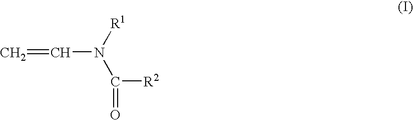
where R¹ and R², which may be identical or different, are each selected from the group consisting of hydrogen and C₁-C₆-alkyl. Useful monomers include for example N-vinylformamide (R¹═R²═H in formula I), N-vinyl-N-methylformamide, N-vinylacetamide, N-vinyl-N-methylacetamide, N-vinyl-N-ethylacetamide, N-vinyl-N-methylpropionamide and N-vinylpropionamide. The monomers mentioned may be polymerized either alone or mixed with each other or together with other monoethylenically unsaturated monomers to prepare the polymers. Preference is given to starting from homo- or copolymers of N-vinylformamide. Polymers containing vinylamine units are known for example from U.S. Pat. No. 4,421,602, EP-A-0 216 387 and EP-A-0 251 182. They are obtained by hydrolysis, with acids, bases or enzymes, of polymers containing monomers of the formula (I) in polymerized form.

Useful monoethylenically unsaturated monomers for copolymerization with N-vinylcarboxamides include all compounds that are copolymerizable therewith. Examples thereof are vinyl esters of saturated carboxylic acids of from 1 to 6 carbon atoms such as vinyl formate, vinyl acetate, vinyl propionate and vinyl butyrate and vinyl ethers such as C₁-C₆-alkyl vinyl ethers, for example methyl vinyl ether or ethyl vinyl ether. Useful comonomers further include ethylenically unsaturated C₃-C₆-carboxylic acids, for example acrylic acid, methacrylic acid, maleic acid, crotonic acid, itaconic acid and vinylacetic acid and also their alkali metal and alkaline earth metal salts, esters, amides and nitriles of the carboxylic acids mentioned, for example methyl acrylate, methyl methacrylate, ethyl acrylate and ethyl methacrylate.

Useful monoethylenically unsaturated monomers for copolymerization with N-vinylcarboxamides further include carboxylic esters derived from glycols or polyalkylene glycols where in each case only one OH group is esterified, for example hydroxyethyl acrylate, hydroxyethyl methacrylate, hydroxypropyl acrylate, hydroxybutyl acrylate, hydroxypropyl methacrylate, hydroxybutyl methacrylate and also monoacrylate esters of polyalkylene glycols having a molar mass from 500 to 10 000. Useful comonomers further include esters of ethylenically unsaturated carboxylic acids with amino alcohols such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate, dimethylaminobutyl acrylate and diethylaminobutyl acrylate. Basic acrylates can be used in the form of the free bases, the salts with mineral acids such as hydrochloric acid, sulfuric acid or nitric acid, the salts with organic acids such as formic acid, acetic acid, propionic acid or sulfonic acids or in quaternized form. Useful quaternizing agents include for example dimethyl sulfate, diethyl sulfate, methyl chloride, ethyl chloride or benzyl chloride.

Useful comonomers further include amides of ethylenically unsaturated carboxylic acids such as acrylamide, methacrylamide and also N-alkylmonoamides and -diamides of monoethylenically unsaturated carboxylic acids with alkyl radicals of from 1 to 6 carbon atoms, for example N-methylacrylamide, N,N-dimethylacrylamide, N-methylmethacrylamide, N-ethylacrylamide, N-propylacrylamide and tert-butylacrylamide and also basic (meth)acrylamides, for example dimethylaminoethylacrylamide, dimethylaminoethylmethacrylamide, diethyl-aminoethylacrylamide, diethylaminoethylmethacrylamide, dimethylaminopropylacrylamide, diethylaminopropylacrylamide, dimethylaminopropylmethacrylamide and diethylaminopropylmethacrylamide.

Useful comonomers further include N-vinylpyrrolidone, N-vinylcaprolactam, acrylonitrile, methacrylonitrile, N-vinylimidazole and also substituted N-vinylimidazoles such as, for example N-vinyl-2-methylimidazole, N-vinyl-4-methylimidazole, N-vinyl-5-methylimidazole, N-vinyl-2-ethylimidazole and N-vinylimidazolines such as N-vinylimidazoline, N-vinyl-2-methylimidazoline and N-vinyl-2-ethylimidazoline. N-Vinylimidazoles and N-vinylimidazolines are used not only in the form of their free bases but also after neutralization with mineral acids or organic acids or after quaternization, the quaternization being preferably effected with dimethyl sulfate, diethyl sulfate, methyl chloride or benzyl chloride. Also useful are diallyldialkylammonium halides, for example diallyldimethylammonium chlorides.

Useful comonomers further include sulfo-containing monomers, for example vinylsulfonic acid, allylsulfonic acid, methallylsulfonic acid, styrenesulfonic acid, the alkali metal or ammonium salts of these acids or 3-sulfopropyl acrylate, and the amphoteric copolymers contain more cationic units than anionic units, so that the polymers have a net cationic charge.

The copolymers contain for example
from 99.99 to 1 mol %, preferably from 99.9 to 5 mol %, of N-vinylcarboxamides of the formula (I) and
from 0.01 to 99 mol %, preferably from 0.1 to 95 mol %, of other monoethylenically unsaturated monomers copolymerizable therewith
   in copolymerized form.

To prepare polymers containing vinylamine units, it is preferable to start from homopolymers of N-vinylformamide or from copolymers obtainable by copolymerization of
N-vinylformamide with
vinyl formate, vinyl acetate, vinyl propionate, acrylonitrile, N-vinylcaprolactam, N-vinylurea, acrylic acid, N-vinylpyrrolidone or C₁-C₆-alkyl vinyl ethers
   and subsequent hydrolysis of the homo- or copolymers to form vinylamine units from the copolymerized N-vinylformamide units, the degree of hydrolysis being for example in the range from 0.1 to 100 mol %.

The hydrolysis of the hereinabove described polymers is effected according to known lo processes by the action of acids, bases or enzymes. This converts the copolymerized monomers of the hereinabove indicated formula (I) through detachment of the group 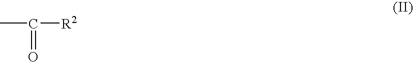
where R is as defined for the formula (I), into polymers which contain vinylamine units of the formula (III) 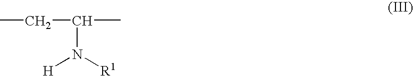
where R¹ is as defined for the formula (I). When acids are used as hydrolyzing agents, the units (III) are present as ammonium salt.

The homopolymers of the N-vinylcarboxamides of the formula (1) and their copolymers may be hydrolyzed to an extent in the range from 0.1 to 100 mol %, preferably to an extent in the range from 70 to 100 mol %. In most cases, the degree of hydrolysis of the homo- and copolymers is in the range from 5 to 95 mol %. The degree of hydrolysis of the homopolymers is synonymous with the vinylamine units content of the polymers. In the case of copolymers containing units derived from vinyl esters, the hydrolysis of the N-vinylformamide units can be accompanied by a hydrolysis of the ester groups with the formation of vinyl alcohol units. This is the case especially when the hydrolysis of the copolymers is carried out in the presence of aqueous sodium hydroxide solution. Copolymerized acrylonitrile is likewise chemically modified in the hydrolysis, for example converted into amide groups or carboxyl groups. The homo- and copolymers containing vinylamine units may optionally contain up to 20 mol % of amidine units, formed for example by reaction of formic acid with two adjacent amino groups or by intramolecular reaction of an amino group with an adjacent amide group, for example of copolymerized N-vinylformamide. The molar masses of the polymers containing vinylamine units range for example from 1 000 to 10 million, preferably from 10 000 to 5 million (determined by light scattering). This molar mass range corresponds for example to K values of from 5 to 300, preferably from 10 to 250 (determined by the method of H. Fikentscher in 5% aqueous sodium chloride solution at 25° C. and a polymer concentration of 0.5% by weight).

The polymers containing vinylamine units are preferably used in salt-free form. Salt-free aqueous solutions of polymers containing vinylamine units are preparable for example from the hereinabove described salt-containing polymer solutions by ultrafiltration using suitable membranes having molecular weight cutoffs at for example from 1 000 to 500 000 dalton, preferably from 10 000 to 300 000 dalton. The hereinbelow described aqueous solutions of other polymers containing amino and/or ammonium groups are likewise obtainable in salt-free form by ultrafiltration.

Useful cationic polymers further include polyethyleneimines. Polyethyleneimines are prepared for example by polymerizing ethyleneimine in aqueous solution in the presence of acid-detaching compounds, acids or Lewis acids. Polyethyleneimines have for example molar masses of up to 2 million, preferably from 200 to 500 000. Particular preference is given to using polyethyleneimines having molar masses of from 500 to 100 000. Useful polyethyleneimines further include water-soluble crosslinked polyethyleneimines which are obtainable by reaction of polyethyleneimines with crosslinkers such as epichlorohydrin or bischlorohydrin ethers of polyalkylene glycols containing from 2 to 100 ethylene oxide and/or propylene oxide units. Also useful are amidic polyethyleneimines which are obtainable for example by amidation of polyethyleneimines with C₁-C₂₂-monocarboxylic acids. Useful cationic polymers further include alkylated polyethyleneimines and alkoxylated polyethyleneimines. Alkoxylation is carried out using for example from 1 to 5 ethylene oxide or propylene oxide units per NH unit in the polyethyleneimine.

Useful polymers containing amino and/or ammonium groups also include polyamidoamines, which are preparable for example by condensing dicarboxylic acids with polyamines. Useful polyamidoamines are obtained for example when dicarboxylic acids having from 4 to 10 carbon atoms are reacted with polyalkylenepolyamines containing from 3 to 10 basic nitrogen atoms in the molecule. Useful dicarboxylic acids include for example succinic acid, maleic acid, adipic acid, glutaric acid, suberic acid, sebacic acid or terephthalic acid. Polyamidoamines may also be prepared using mixtures of dicarboxylic acids as well as mixtures of plural polyalkylenepolyamines. Useful polyalkylenepolyamines include for example diethylenetriamine, triethylenetetramine, tetraethylenepentamine, dipropylenetriamine, tripropylenetetramine, dihexamethylenetriamine, aminopropylethylenediamine and bis-aminopropylethylenediamine. The dicarboxylic acids and polyalkylenepolyamines are heated at an elevated temperature, for example at from 120 to 220° C., preferably at from 130 to 180° C., to prepare the polyamidoamines. The water of condensation formed is removed from the system. The condensation may also employ lactones or lactams of carboxylic acids having from 4 to 8 carbon atoms. The amount of a polyalkylenepolyamine used per mole of a dicarboxylic acid is for example in the range from 0.8 to 1.4 mol.

Amino-containing polymers further include ethyleneimine-grafted polyamidoamines. They are obtainable from the hereinabove described polyamidoamines by reaction with ethyleneimine in the presence of acids or Lewis acids such as sulfuric acid or boron trifluoride etherates at for example from 80 to 100° C. Compounds of this kind are described for example in DE-B-24 34 816.

Useful cationic polymers also include crosslinked or uncrosslinked polyamidoamines which may additionally have been grafted with ethyleneimine prior to crosslinking. Crosslinked ethyleneimine-grafted polyamidoamines are water soluble and have for example an average molar weight of from 3 000 to 1 million dalton. Customary crosslinkers include for example epichlorohydrin or bischlorohydrin ethers of alkylene glycols and polyalkylene glycols.

Further examples of cationic polymers that contain amino and/or ammonium groups are polydiallyldimethylammonium chlorides. Polymers of this kind are likewise known.

Useful cationic polymers further include copolymers of for example 1-99 mol %, preferably 30-70 mol %, of acrylamide and/or methacrylamide and/or 1-vinylpyrrolidone and 99-1 mol %, preferably 70-30 mol %, of cationic monomers such as dialkylaminoalkylacrylamide, dialkylaminoalkyl acrylate, dialkylaminoalkylmethacrylamide and/or dialkylaminoalkyl methacrylate. The basic acrylamides and methacrylamides are preferably likewise present in acid-neutralized form or in quaternized form. Examples are N-trimethylammoniumethylacrylamide chloride, N-trimethylammoniumethylmethacrylamide chloride, N-trimethylammoniumethyl methacrylate chloride, N-trimethylammoniumethyl acrylate chloride, trimethylammoniumethylacrylamide methosulfate, trimethylammoniumethylmethacrylamide methosulfate, N-ethyldimethylammoniumethylacrylamide ethosulfate, N-ethyldimethylammoniumethylmethacrylamide ethosulfate, trimethylammoniumpropylacrylamide chloride, trimethylammoniumpropylmethacrylamide chloride, trimethylammoniumpropylacrylamide methosulfate, trimethylammoniumpropylmethacrylamide methosulfate and N-ethyldimethylammoniumpropylacrylamide ethosulfate.

Preference is given to trimethylammoniumpropylmethacrylamide chloride.

Further useful cationic monomers for preparing (meth)acrylamide copolymers are diallyldimethylammonium halides and also basic (meth)acrylates. Useful examples are copolymers of 1-99 mol %, preferably 30-70 mol %, of acrylamide and/or methacrylamide and 99-1 mol %, preferably 70-30 mol %, of dialkylaminoalkyl acrylates and/or methacrylates such as copolymers of acrylamide and N,N-dimethylaminoethyl acrylate or copolymers of acrylamide and dimethylaminopropyl acrylate. Basic acrylates or methacrylates are preferably present in acid neutralized from or in quaternized form. Quaternization may be effected for example with methyl chloride or with dimethyl sulfate.

Useful cationic polymers containing amino and/or ammonium groups further include polyallylamines. Polymers of this kind are obtained by homopolymerization of allylamine, preferably in acid neutralized form or in quaternized form, or by copolymerization of allylamine with other monoethylenically unsaturated monomers described above as comonomers for N-vinylcarboxamides.

The cationic polymers have for example K values of from 8 to 300, preferably from 100 to 180 (determined by the method of H. Fikentscher in 5% aqueous sodium chloride solution at 25° C. and a polymer concentration of 0.5% by weight). At pH 4.5, for example, they have a charge density of at least 1, preferably at least 4, meq/g of polyelectrolyte.

Examples of preferred cationic polymers are polydimethyldiallylammonium chloride, polyethyleneimine, polymers containing vinylamine units, copolymers of acrylamide or methacrylamide that contain basic monomers in copolymerized form, polymers containing lysine units or mixtures thereof. Examples of preferred cationic polymers are:
copolymers of 50% of vinylpyrrolidone and 50% of trimethylammoniumethyl methacrylate methosulfate, M_{w} 1 000-500 000;
copolymers of 30% of acrylamide and 70% of trimethylammoniumethyl methacrylate methosulfate, M_{w} 1 000-1 000 000;
copolymers of 70% of acrylarnide and 30% of dimethylaminoethylmethacrylamide, M_{w} 1 000-1 000 000;
copolymers of 50% of hydroxyethyl methacrylate and 50% of 2-dimethylarninoethylmethacrylamide, M_{w} 1 000-500 000;
polylysines of M_{w} 250-250 000, preferably 500-100 000, and also lysine cocondensates having M_{w} molar masses from 250 to 250 000, the cocondensable component being selected for example from amines, polyamines, ketene dimers, lactams, alcohols, alkoxylated amines, alkoxylated alcohols and/or nonproteinogenic amino acids,
vinylamine homopolymers, 1-99% of hydrolyzed polyvinylformamides, copolymers of vinylformamide and vinyl acetate, vinyl alcohol, vinylpyrrolidone or acrylamide having molar masses of 3 000-500 000,
1-vinylimidazole homopolymers, 1-vinylimidazole copolymers with 1-vinylpyrrolidone, vinylformamide, acrylamide or vinyl acetate having molar masses of from 5 000 to 500 000 and also their quaternary derivatives, for example copolymer of 75% by weight of 1-vinylimidazole and 25% by weight of 1-vinylpyrrolidone having M_{w}=50 000, copolymer of 50% by weight of 3-methyl-1-vinylimidazolium chloride and 50% by weight of 1-vinylpyrrolidone having M_{w}=75 000,
polyethyleneimines, crosslinked polyethyleneimines or amidated polyethyleneimines having molar masses of from 500 to 3 000 000, for example polyethyleneimine of molar mass 25 000 or high molecular weight polyethyleneimine of molar mass 2 000 000,
amine-epichlorohydrin polycondensates which contain imidazole, piperazine, C₁-C₈-alkylamines, C₁-C₈-dialkylamines and/or dimethylaminopropylamine as amine component and have a molar mass of from 500 to 250 000,
polydimethyldiallylammonium chloride, M_{w} 2 000-2 000 000, and
polymers containing basic (meth)acrylamide or (meth)acrylic ester units, polymers containing basic quaternary (meth)acrylamide or (meth)acrylic ester units having molar masses of from 10 000 to 2 000 000.

Particular preference is given to polyethyleneimines, crosslinked polyethyleneimines, amidated polyethyleneimines, amine-epichlorohydrin polycondensates with imidazole or piperazine as amine component, polydimethyldiallylammonium chlorides and also polyvinylformamides having a degree of hydrolysis of from 30 to 100%.

It is also possible to include a minor amount (<10% by weight) of anionic comonomers, for example acrylic acid, methacrylic acid, vinylsulfonic acid or alkali metal salts of the acids mentioned.

C Compositions for Treating Surfaces

There are many industrial and domestic applications where the modification of the properties of textile and nontextile surfaces with polymer dispersions is important. It is not always possible to effect the modification of the surfaces by impregnating, spraying and spreading operations involving concentrated dispersions. It is frequently desirable to effect the modification of the surface by rinsing the surface with a very dilute liquor that contains an active substance. It is frequently desirable to combine the modifying treatment of the surface with a wash, clean and/or conditioning or impregnation of the surface. Surfaces contemplated include in particular surfaces of textile materials such as cotton fabrics and cotton blend fabrics, but also hard surfaces.

The present invention also provides a process for modifying the surface of textile and nontextile materials, which comprises cationically modified particulate polyurethanes having a particle size from 10 nm to 100 μm being applied to said surface of said materials from an aqueous dispersion and said materials being dried.

Preferably, the cationically modified particulate polyurethanes are applied to the surface from an aqueous dispersion having a polyurethane content of ≦5% by weight.

The surfaces of textile materials may be modified for example to provide them with water resistance, a soil release finish, a soil resist finish, improved integrity of the fiber ensemble, hand improvement, protection against wrinkling and creasing and protection against chemical or mechanical effects and damage.

Surfaces contemplated here are in particular surfaces of textile materials such as cotton fabrics and cotton blend fabrics. In addition, installed carpeting and furniture covers can be treated according to the present invention.

The surfaces of nontextile materials may be modified for example to provide them with water resistance, a soil release finish, a soil resist finish and protection against chemical or mechanical effects and damage.

Surfaces of nontextile materials include for example the macroscopic, hard surfaces of floor and wall coverings, exposed concrete, brick exteriors, rendered exteriors, glass, ceramic, metal, enamel, plastic and wood and also the microscopic surfaces of porous bodies, foams, woods, of leather, porous building materials and pulp fleeces.

The cationically modified particulate anionic polyurethanes are used for modifying surfaces of the hereinabove exemplified materials as a surface-modifying ingredient in rinsing or conditioning compositions, washing or cleaning compositions for textile and nontextile materials. Especially contemplated are uses in washing, cleaning and aftertreating of textiles, leather, wood, floor coverings, glass, ceramics and other surfaces in the home and in the industrial sector.

The cationically modified particulate anionic polyurethanes are used in the form of a dilute, predominantly aqueous, dispersion. The use takes the form of a treatment of the surfaces with washing, cleaning and rinsing liquors to which the polymers are added either directly or by means of a liquid or solid formulation, or in the form of a finely divided application of a liquid formulation, for example by spraying.

The cationically modified particulate anionic polyurethanes can be used for example as sole active component in aqueous rinsing and conditioning compositions and, depending on the composition of the polyurethane, provide for easier soil release in a subsequent wash, reduced soil attachment in the use of the textiles, improved structural integrity of fibers, improved shape retention and structural integrity for fabrics, water repellency on the surface of the washed material and also hand improvement.

The concentration of the cationically modified particulate polyurethanes when used in a rinsing or conditioning bath, a washing liquor or cleaning bath is for example in the range from 0.0002 to 5% by weight, preferably in the range from 0.0005 to 1.0% by weight and more preferably in the range from 0.002 to 0.1% by weight.

The cationic modification of the particulate polyurethanes is preferably effected prior to use in the aqueous treatment compositions, but can also be effected in the course of the production of the aqueous treatment compositions, by mixing aqueous dispersions of the particulate polyurethanes with the other ingredients of the treatment composition in the presence of cationic polymers and optionally cationic surfactants. The particulate polyurethanes or formulations containing them can also be added directly to the rinsing, washing or cleaning liquor provided the liquor contains adequate amounts of cationic polymers in dissolved form.

Compositions for treating surfaces can have the following composition for example:
(a) from 0.1 to 50% by weight, preferably from 0.5 to 25% by weight, of the cationically modified particulate anionic polyurethanes,
(b) from 0 to 60% by weight of at least one customary additive such as acids or bases, inorganic builders, organic cobuilders, surfactants, polymeric dye transfer inhibitors, polymeric soil antiredeposition agents, soil release polymers, enzymes, complexing agents, corrosion inhibitors, waxes, silicone oils, light stabilizers, dyes, solvents, hydrotropes, thickeners and/or alkanolamines,
(c) from 0 to 99.9% by weight of water,
   components (a) to (c) adding up to 100% by weight.

The present invention also provides a textile treatment composition including
a) from 0.1 to 40% by weight, preferably from 0.5 to 25% by weight, of the cationically modified particulate anionic polyurethanes,
b) from 0 to 30% by weight of silicones,
c) from 0 to 30% by weight of cationic and/or nonionic surfactants,
d) from 0 to 60% by weight of further ingredients such as further wetting agents, softeners, lubricants, water-soluble, film-forming and adhesive polymers, scents, dyes, stabilizers, fiber and color protection additives, viscosity modifiers, soil release additives, corrosion control additives, bactericides, preservatives and spraying assistants, and
e) from 0 to 99.9% by weight of water,
   components a) to e) adding up to 100% by weight.

Preferred silicones b) are amino-containing silicones, which are preferably present in microemulsified form, alkoxylated, especially ethoxylated, silicones, polyalkylene oxide-polysiloxanes, polyalkylene oxide-aminopolydimethylsiloxanes, silicones having quaternary ammonium groups (silicone quats) and silicone surfactants.

Useful softeners or lubricants include for example oxidized polyethylenes or paraffinic waxes and oils. Useful water-soluble, film-forming and adhesive polymers include for example (co)polymers based on acrylamide, N-vinylpyrrolidone, vinylformamide, N-vinylimidazole, vinylamine, N,N′-dialkylaminoalkyl (meth)acrylates, N,N′-dialkylaminoalkyl, (meth)acrylamides, (meth)acrylic acid, alkyl (meth)acrylates and/or vinylsulfonate. The aforementioned basic monomers may also be used in quaternized form.

A textile treatment composition to be applied to the textile material by spraying may additionally include a spraying assistant. In some cases, it may also be preferable to include alcohols such as ethanol, isopropanol, ethylene glycol or propylene glycol in the formulation. Further customary additives are scents, dyes, stabilizers, fiber and color protection additives, viscosity modifiers, soil release additives, corrosion control additives, bactericides and preservatives in the customary amounts.

The textile treatment composition may generally also be applied by spraying in the course of ironing after laundering. This not only substantially facilitates the ironing, but also imparts sustained wrinkle and crease resistance to the textiles.

The cationically modified particulate inorganic polyurethanes can also be used in the main wash cycle of a washing machine used for washing textiles.

The present invention further provides a solid laundry detergent formulation including
a) from 0.05 to 20% by weight of the cationically modified particulate anionic polyurethanes,
b) from 0 to 20% by weight of silicones,
c) from 0.1 to 40% by weight of nonionic and/or anionic surfactants,
d) from 0 to 50% by weight of inorganic builders,
e) from 0 to 10% by weight of organic cobuilders,
f) from 0 to 60% by weight of other customary ingredients such as extenders, enzymes, perfume, complexing agents, corrosion inhibitors, bleaches, bleach activators, bleach catalysts, cationic surfactants, dye transfer inhibitors, soil antiredeposition agents, soil release polyesters, dyes, bactericides, dissolution improvers and/or disintegrants,
   components a) to f) adding up to 100% by weight.

A solid laundry detergent formulation according to the present invention is customarily pulverulent or granular or in extrudate-or tablet form.

The present invention further provides a liquid laundry detergent formulation including
a) from 0.05 to 20% by weight of the cationically modified particulate anionic polyurethanes,
b) from 0 to 20% by weight of silicones,
c) from 0.1 to 40% by weight of nonionic and/or anionic surfactants,
d) from 0 to 20% by weight of inorganic builders,
e) from 0 to 10% by weight of organic cobuilders,
f) from 0 to 60% by weight of other customary ingredients such as sodium carbonate, enzymes, perfume, complexing agents, corrosion inhibitors, bleaches, bleach activators, bleach catalysts, cationic surfactants, dye transfer inhibitors, soil antiredeposition agents, soil release polyesters, dyes, bactericides, nonaqueous solvents, solubilizers, hydrotropes, thickeners and/or alkalolamines,
g) from 0 to 99.85% by weight of water,
   components a) to g) adding up to 100% by weight.

Useful silicones b) include the abovementioned silicones.

Useful anionic surfactants c) include in particular:
(fatty) alcohol sulfates of (fatty) alcohols having from 8 to 22, preferably from 10 to 18, carbon atoms, for example C₉- to C₁₁-alcohol sulfates, C₁₂- to C₁₄-alcohol sulfates, C₁₂- to C₁₈-alcohol sulfates, lauryl sulfate, cetyl sulfate, myristyl sulfate, palmityl sulfate, stearyl sulfate and tallow fatty alcohol sulfate;
sulfated alkoxylated C₈- to C₂₂-alcohols (alkyl ether sulfates). Compounds of this kind are prepared for example by first alkoxylating a C₈- to C₂₂-alcohol, preferably a C₁₀- to C₁₈-alcohol, for example a fatty alcohol, and then sulfating the alkoxylation product. The alkoxylation is preferably carried out using ethylene oxide;
linear or branched C₈- to C₂₀-alkylbenzenesulfonates (LAS), preferably linear C₉- to C₁₃-alkylbenzenesulfonates and -alkyltoluenesulfonates;
alkanesulfonates such as C₈- to C₂₄-alkanesulfonates, preferably C₁₀- to C₁₈-alkanesulfonates;
soaps such as, for example, the sodium and potassium salts of C₈- to C₂₄-carboxylic acids.

The anionic surfactants mentioned are preferably included in the laundry detergent in the form of salts. Suitable cations in these salts are alkali metal ions such as sodium, potassium and lithium ions and ammonium ions such as hydroxyethylammonium, di(hydroxyethyl)ammonium and tri(hydroxyethyl)ammonium.

Useful nonionic surfactants c) are in particular:
alkoxylated linear or branched C₈- to C₂₂-alcohols such as fatty alcohol alkoxylates or oxo alcohol alkoxylates. These may have been alkoxylated with ethylene oxide, propylene oxide and/or butylene oxide. Useful surfactants here include all alkoxylated alcohols which contain at least two molecules of one of the aforementioned alkylene oxides. Here it is possible to use block polymers of ethylene oxide, propylene oxide and/or butylene oxide or addition products which contain the aforementioned alkylene oxides in random distribution. Nonionic surfactants generally contain from 2 to 50, preferably from 3 to 20, mol of at least one alkylene oxide per mole of alcohol. The alkylene oxide component is preferably ethylene oxide. The alcohols preferably have from 10 to 18 carbon atoms. Depending on the type of alkoxylation catalyst used to make them, alkoxylates have a broad or narrow alkylene oxide homolog distribution;
alkylphenol alkoxylates such as alkylphenol ethoxylates having C₆-C₁₄-alkyl chains and from 5 to 30 alkylene oxide units;
alkylpolyglucosides having from 8 to 22, preferably from 10 to 18, carbon atoms in the alkyl chain and generally from 1 to 20, preferably from 1.1 to 5, glucoside units;
N-alkylglucamides, fatty acid amide alkoxylates, fatty acid alkanolamide alkoxylates and also block copolymers of ethylene oxide, propylene oxide and/or butylene oxide.

Useful inorganic builders d) are in particular:
crystalline or amorphous aluminosilicates having ion-exchanging properties such as zeolites in particular. Useful zeolites include in particular zeolites A, X, B, P, MAP and HS in their sodium form or in forms in which sodium has been partly replaced by other cations such as lithium, potassium, calcium, magnesium or ammonium;
crystalline silicates such as in particular disilicates or sheet-silicates, for example δ-Na₂Si₂O₅ or P—Na₂Si₂O₅. Silicates can be used in the form of their alkali metal, alkaline earth metal or ammonium salts, preferably as sodium, lithium and magnesium silicates;
amorphous silicates such as for example sodium metasilicate or amorphous disilicate;
carbonates and bicarbonates. These can be used in the form of their alkali metal, alkaline earth metal or ammonium salts. Preference is given to sodium, lithium and magnesium carbonates or bicarbonates, especially sodium carbonate and/or sodium bicarbonate;
polyphosphates such as for example pentasodium triphosphate.

Useful organic cobuilders e) include in particular low molecular weight, oligomeric or polymeric carboxylic acids.
Useful low molecular weight carboxylic acids include for example citric acid, hydrophobic modified citric acid such as for example agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids such as for example nitrilotriacetic acid, β-alaninediacetic acid, ethylenediaminetetraacetic acid, serinediacetic acid, isoserinediacetic acid, N-(2-hydroxyethyl)iminodiacetic acid, ethylenediaminedisuccinic acid and methyl- and ethylglycinediacetic acid;
useful oligomeric or polymeric carboxylic acids include for example homopolymers of acrylic acid, oligomaleic acids, copolymers of maleic acid with acrylic acid, methacrylic acid, C₂-C₂₂-olefins such as for example isobutene or long-chain α-olefins, vinyl alkyl ethers having C₁-C₈-alkyl groups, vinyl acetate, vinyl propionate, (meth)acrylic esters of C₁-C₈-alcohols and styrene. Preference is given to using the homopolymers of acrylic acid and copolymers of acrylic acid with maleic acid. Polyaspartic acids are also useful as organic cobuilders. Oligomeric and polymeric carboxylic acids are used in acid form or as sodium salt.

Useful bleaches include for example adducts of hydrogen peroxide with inorganic salts such as for example sodium perborate monohydrate, sodium perborate tetrahydrate or sodium carbonate perhydrate or percarboxylic acids such as for example phthalimidopercaproic acid.

Useful bleach activators include for example N,N,N′,N′-tetraacetylethylenediamine (TAED), sodium p-nonanoyloxybenzenesulfonate or N-methylmorpholinium acetonitrile methosulfate.

Preferred enzymes for use in laundry detergents are proteases, lipases, amylases, cellulases, oxidases or peroxidases.

Useful dye transfer inhibitors include for example homo- and copolymers of 1-vinylpyrrolidone, of 1-vinylimidazole or of 4-vinylpyridine N-oxide. Homo- or copolymers of 4-vinylpyridine which have been reacted with chloroacetic acid are likewise useful as dye transfer inhibitors.

A detailed description of the laundry detergent ingredients mentioned may be found for example in WO 99/06524 or WO 99/04313 and in Liquid Detergents, Editor: Kuo-Yann Lai, Surfactant Sci. Ser., Vol. 67, Marcel Decker, New York, 1997, p. 272-304. For typical ingredients also see the Detergents chapter (part 3, Detergent Ingredients, part 4, Household Detergents and part 5, Institutional Detergents) in Ullmann's Encyclopedia of Industrial Chemistry, Sixth Edition, 2000 Electronic Version 2.0.

The concentration of the cationically modified particulate anionic polyurethanes in the washing liquor is for example in the range from 10 to 5 000 ppm and preferably in the range from 50 to 1 000 ppm. The textiles treated with the cationically modified particulate polyurethanes in the main wash cycle of a washing machine not only wrinkle substantially less than untreated textiles, they are also easier to iron, softer and smoother, more dimensionally and shape stable and, because of the fiber and color protection, look less used, ie exhibit less fluff and fewer knots and less color damage or fading, after repeated washing.

The cationically modified particulate anionic polyurethanes can also be used in the rinse or conditioning cycle following the main wash cycle. The concentration of the particulate polyurethanes in the washing liquor is for example in the range from 10 to 5 000 ppm and is preferably in the range from 50 to 1 000 ppm. The ingredients typical of a fabric conditioner can be included in the rinsing liquor, if desired. Textiles treated in this way and then dried on the line or preferably in a tumble dryer likewise exhibit a very high level of crease control associated with the above-described positive outworkings on the ironing. Crease control can be substantially enhanced by briefly ironing the textiles once after drying. The treatment in the conditioning or rinse cycle also has a favorable effect on the shape retention of the textiles. It further inhibits the formation of knots and fluff and suppresses color damage.

The present invention further provides a laundry rinse conditioner including
a) from 0.05% to 40% by weight of the cationically modified particulate anionic polyurethanes,
b) from 0 to 20% by weight of silicones,
c) from 0.1 to 40% by weight of cationic surfactants,
d) from 0 to 30% by weight of nonionic surfactants,
e) from 0 to 30% by weight of other customary ingredients such as lubricants, wetting agents, film-forming polymers, scents, dyes, stabilizers, fiber and color protection additives, viscosity modifiers, soil release additives, corrosion control additives, bactericides and preservatives, and
f) from 0 to 99.85% by weight of water,
   components a) to f) adding up to 100% by weight.

Useful silicones b) include the abovementioned silicones.

Preferred cationic surfactants c) are selected from the group of the quaternary diesterammonium salts, the quaternary tetraalkylammonium salts, the quaternary diamidoammonium salts, the amidoamine esters and imidazolium salts. These are preferably present in an amount of from 3 to 30% by weight in the laundry refreshers. Examples are quaternary diesterammonium salts which have two C₁₁- to C₂₂-alk(en)ylcarbonyloxy(mono- to pentamethylene) radicals and two C₁- to C₃-alkyl or -hydroxyalkyl radicals on the quaternary nitrogen atom and, for example, chloride, bromide, methosulfate or sulfate as counterion.

Quaternary diesterammonium salts further include in particular those which have a C₁₁- to C₂₂-alk(en)ylcarbonyloxytrimethylene radical bearing a C₁₁- to C₂₂-alk(en)ylcarbonyloxy radical on the central carbon atom of the trimethylene group and three C₁- to C₃-alkyl or -hydroxyalkyl radicals on the quaternary nitrogen atom and, for example, chloride, bromide, methosulfate or sulfate as counterion.

Quaternary tetraalkylammonium salts are in particular those which have two C₁- to C₆-alkyl radicals and two C₈- to C₂₄-alk(en)yl radicals on the quaternary nitrogen atom and, for example, chloride, bromide, methosulfate or sulfate as counterion.

Quaternary diamidoammonium salts are in particular those which bear two C₈- to C₂₄-alk(en)ylcarbonylaminoethylene radicals, a substituent selected from hydrogen, methyl, ethyl and polyoxyethylene having up to 5 oxyethylene units and as fourth radical a methyl group on the quaternary nitrogen atom and, for example, chloride, bromide, methosulfate or sulfate as counterion.

Amidoamino esters are in particular tertiary amines bearing a C₁₁- to C₂₂-alk(en)ylcarbonylamino(mono- to trimethylene) radical, a C₁₁- to C₂₂-alk(en)ylcarbonyloxy(mono- to trimethylene) radical and a methyl group as substituents on the nitrogen atom.

Imidazolinium salts are in particular those which bear a C₁₄- to C₁₈-alk(en)yl radical in position 2 of the heterocycle, a C₁₄- to C₁₈-alk(en)ylcarbonyl(oxy or amino)ethylene radical on the neutral nitrogen atom and hydrogen, methyl or ethyl on the nitrogen atom carrying the positive charge, while counterions here are for example chloride, bromide, methosulfate or sulfate.

The examples hereinbelow illustrate the invention.

### EXAMPLES

Preparation of Anionic Dispersions I and II

### Example 1

Dispersion I

400 g (0.200 mol) of a polyesterpolyol formed from adipic acid, neopentylglycol and hexanediol and having an OH number of 56 were initially charged to a stirred tank at 50° C. 36.1 g (0.1624 mol) of isophorone diisocyanate, 42.9 g (0.1624 mol) of bis-(4-isocyanatocyclohexyl)methane and 80 g of acetone were added. The mixture was stirred at 90° C. for 60 min before 0.15 g of dibutyltin dilaurate was added. Stirring was continued for a further 120 min. The mixture was then diluted with 500 g of acetone and at the same time cooled to 50° C. The NCO content of the solution was 0.99% (reckoned 0.94%). The addition of 22.5 g (0.0534 mol) of a 50% by weight aqueous solution of the sodium salt of aminoethyl aminoethane sulfonic acid was followed by dispersion in the course of 5 min by addition of 800 g of water. After dispersion, a solution of 3.9 g (0.0379 mol) of diethylenetriamine and 1.8 g (0.0106 mol) of isophoronediamine in 50 g of water was added. The acetone was removed by distillation to leave a finely divided aqueous anionic PU dispersion having a solids content of about 40%.

### Example 2

Dispersion II

400 parts of a propylene glycol having an OH number of 56 were dewatered in a stirred flask at 130° C. and 20 Torr for 30 minutes. The polyether was cooled down, dissolved in 50 parts of N-methylpyrrolidone and admixed with 26.8 parts of dimethylolpropionic acid. This was followed by stirring with 95.7 parts of tolylene diisocyanate (isomer ratio 2.4/2.6=80/20) at 110° C. for 120 minutes. This was followed by dilution with 400 parts of acetone and cooling to 50° C. 16 parts of triethylamine were added dropwise to the solution thus obtained, followed 10 minutes later by 900 parts of water, added dropwise, before the acetone was distilled off under reduced pressure to leave a very finely divided stable anionic dispersion having a solids content of 40%.

Preparation of Cationically Modified Dispersions III, IV and V

The following cationic polymers were used:
Polymer 1: polyethyleneimine having a molar mass of 25 000
Polymer 2: high molecular weight polyethyleneimine having a molar mass of 2 000 000
Polymer 3: polydiallyldimethylammonium chloride having a molar mass of 100 000.

### Example 3

Dispersion III

50 g of dispersion I were metered into 50 g of a 0.8% by weight aqueous solution of polymer 1 at room temperature and pH 7 in the course of 10 minutes. The finely divided dispersion obtained was stable for several months.

### Example 4

Dispersion IV

50 g of dispersion I were metered into 100 g of a 0.8% by weight aqueous solution of polymer 2 at room temperature and pH 7 in the course of 10 minutes. The finely divided dispersion obtained was stable for several months.

### Example 5

Dispersion V

50 g of dispersion II were metered into 50 g of a 1.2% by weight aqueous solution of polymer 3 at room temperature and pH 7 in the course of 10 minutes. The finely divided dispersion obtained was stable for several months.

Electrophoretic measurements demonstrated the coating of the anionic PU particles with the cationic polymer. The coating caused the direction of migration of the particles in an electric field to reverse.

Measurement of Dry Crease Recovery Angle

### Inventive Examples 6 to 8 and Comparative Examples 1 to 3

Dispersion III was diluted with water (pH 7, water hardness 1 mmol/l) to a solids content of 0.02% by weight. A white cotton fabric (10 g) was suspended in the stirred liquor (600 ml) for 30 minutes. The cotton fabric was then removed and dried. Crease recovery (dewrinkling) was determined on the dry fabric in accordance with DIN 53890. The higher the crease recovery angle after removal of the force acting on the fabric, the better the efficacy of the dispersion. A white cotton fabric was similarly treated with dispersions IV and V and, for comparison, with the unmodified dispersions I and II before the crease recovery angle was determined in similar fashion. The results are reported in Table 1

TABLE 1

| | | Crease recovery angle |
|---|---|---|
| Example | Cotton fabric treated with | Total (warp + fill) |
| Comparative 1 | Dispersion I | 70 |
| Comparative 2 | Dispersion II | 60 |
| Inventive 6 | Dispersion III | 95 |
| Inventive 7 | Dispersion IV | 105 |
| Inventive 8 | Dispersion V | 80 |
| Comparative 3 | untreated | 50 |

The results demonstrate the superior efficacy of the cationically modified polyurethane dispersions II, IV and V over the unmodified anionic polyurethane dispersions I and II.

Application of Dispersions in Rinse Cycle

### Inventive Examples 9 to 12 and Comparative Examples 4 to 6

White sheetlike cotton fabric 30 cm×50 cm in size and having a basis weight of 130 g/m² was washed in the presence of ballast fabric (load: 1.5 kg) at a water hardness of 3 mmol/l. The washing operation was made up of a main wash cycle (Ariel® hydractive laundry detergent, 40° C. coloreds program) and a subsequent rinse cycle. The rinse liquor contained
a) 1000 ppm of a commercially available fabric conditioner (Downy from Lenor®)
b) 1000 ppm of Downy from Lenor+100 ppm of dispersion I, III or IV (active material)
c) 200 ppm of dispersion I, III or IV (active material)

The liquor ratio was 10:1. After the rinse cycle, the fabric was removed and dried in a tumble dryer (cupboard dry program). After drying, the sheetlike fabric samples were visually rated on the lines of AATCC test method 124, where a rating of 1 denotes that the fabric is very wrinkly and has many creases, while a rating of 5 is awarded to wrinkle- and crease-free fabric.

The results are reported in Table 2.

TABLE 2

| Example | Rinse cycle | Co (30 cm × 50 cm) |
|---|---|---|
| Comparative 4 | 1000 ppm Downy | 1.5 |
| Comparative 5 | 1000 ppm Downy + 100 ppm | 2.0 |
| | Dispersion I | |
| 9 | 1000 ppm Downy + 100 ppm | 2.5 |
| | Dispersion III | |
| 10 | 1000 ppm Downy + 100 ppm | 3.0 |
| | Dispersion IV | |
| Comparative 6 | 200 ppm Dispersion I | 2.0 |
| 11 | 200 ppm Dispersion III | 2.5 |
| 12 | 200 ppm Dispersion IV | 3.0 |

The results show that the cationically modified Dispersions III and IV are distinctly superior to anionic Dispersion I.

1-13. (canceled)

14. Cationically modified particulate anionic polyurethanes having a particle size from 10 nm to 10 μm, the particulate polyurethanes being cationically modified through surface coating with cationic polymers.

15. The cationically modified particulate anionic polyurethanes as claimed in claim 14, wherein said particulate polyurethanes contain anionic and cationic and/or nonionic hydrophilic groups.

16. The cationically modified particulate anionic polyurethanes as claimed in claim 14, wherein said cationic polymers used, are selected from polymers containing vinylamine units, polymers containing vinylimidazole units, polymers containing quaternary vinylimidazole units, condensates of imidazole and epichlorohydrin, crosslinked polyamidoamines, ethyleneimine-grafted crosslinked polyamidoamines, polyethyleneimines, alkoxylated polyethyleneimines, crosslinked polyethyleneimines, amidated polyethyleneimines, alkylated polyethyleneimines, polyamines, amine-epichlorohydrin polycondensates, alkoxylated polyamines, polyallylamines, polydimethyldiallylammonium chlorides, polymers containing basic (meth)acrylamide or (meth)acrylic ester units, polymers containing basic quaternary (meth)acrylamide or (meth)acrylic ester units, lysine condensates or combinations thereof.

17. Cationically modified aqueous anionic polyurethane dispersions, comprising cationically modified particulate anionic polyurethanes as claimed in claim 14.

18. A process for modifying the surface of textile and nontextile materials, comprising applying cationically modified particulate anionic polyurethanes, as claimed in claim 14, to said surface of said materials, from an aqueous dispersion and drying said materials.

19. The process as claimed in claim 18, wherein said polyurethanes are applied to said surface from an aqueous dispersion having a polyurethane content of <5% by weight.

20. A composition comprising the cationically modified particulate anionic polyurethanes as claimed in claim 14, as a surface-modifying additive, and one or more additives used in washing, rinsing, conditioning or cleaning compositions.

21. A composition comprising the cationically modified aqueous anionic polyurethane dispersions as claimed in claim 17, and one or more additives used in washing, rinsing or cleaning liquors.

22. A composition for treating surfaces, comprising
(a) from 0.1 to 50% by weight of cationically modified particulate anionic polyurethanes as claimed in claim 14,
(b) from 0 to 60% by weight of at least one customary additive, such as acids or bases, inorganic builders, organic cobuilders, surfactants, polymeric dye transfer inhibitors, polymeric soil antiredeposition agents, soil release polymers, enzymes, complexing agents, corrosion inhibitors, waxes, silicone oils, light stabilizers, dyes, solvents, hydrotropes, thickeners and/or alkanolamines,
(c) from 0 to 99.9% by weight of water,
wherein components (a) to (c) add up to 100% by weight.

23. A textile treatment composition, comprising
a) from 0.1 to 40% by weight of the cationically modified particulate anionic polyurethanes of claim 14,
b) from 0 to 30% by weight of silicones,
c) from 0 to 30% by weight of cationic and/or nonionic surfactants,
d) from 0 to 60% by weight of further ingredients, such as further wetting agents, softeners, lubricants, water-soluble, film-forming and adhesive polymers, scents, dyes, stabilizers, fiber and color protection additives, viscosity modifiers, soil release additives, corrosion control additives, bactericides, preservatives and spraying assistants, and
e) from 0 to 99.9% by weight of water,
wherein components a) to e) add up to 100% by weight.

24. A solid laundry detergent formulation, comprising
a) from 0.05 to 20% by weight of the cationically modified particulate anionic polyurethanes of claim 14,
b) from 0 to 20% by weight of silicones,
c) from 0.1 to 40% by weight of nonionic and/or anionic surfactants,
d) from 0 to 50% by weight of inorganic builders,
e) from 0 to 10% by weight of organic cobuilders,
f) from 0 to 60% by weight of other customary ingredients, such as extenders, enzymes, perfume, complexing agents, corrosion inhibitors, bleaches, bleach activators, cationic surfactants, bleach catalysts, dye transfer inhibitors, soil antiredeposition agents, soil release polyesters, dyes, bactericides, dissolution improvers and/or disintegrants,
wherein components a) to f) add up to 100% by weight.

25. A liquid laundry detergent formulation, comprising
a) from 0.05 to 20% by weight of the cationically modified particulate anionic polyurethanes of claim 14,
b) from 0 to 20% by weight of silicones,
c) from 0.1 to 40% by weight of nonionic and/or anionic surfactants,
d) from 0 to 20% by weight of inorganic builders,
e) from 0 to 10% by weight of organic cobuilders,
f) from 0 to 60% by weight of other customary ingredients, such as sodium carbonate, enzymes, perfume, complexing agents, corrosion inhibitors, bleaches, bleach activators, bleach catalysts, cationic surfactants, dye transfer inhibitors, soil antiredeposition agents, soil release polyesters, dyes, bactericides, nonaqueous solvents, solubilizers, hydrotropes, thickeners and/or alkanolamines,
g) from 0 to 99.85% by weight of water,
wherein components a) to g) add up to 100% by weight.

26. A laundry rinse conditioner, comprising
a) from 0.05% to 40% by weight of the cationically modified particulate anionic polyurethanes of claim 14,
b) from 0 to 20% by weight of silicones,
c) from 0.1 to 40% by weight of cationic surfactants,
d) from 0 to 30% by weight of nonionic surfactants,
e) from 0 to 30% by weight of other customary ingredients, such as silicones, other lubricants, wetting agents, film-forming polymers, scents, dyes, stabilizers, fiber and color protection additives, viscosity modifiers, soil release additives, corrosion control additives, bactericides and preservatives, and
f) from 0 to 99.85% by weight of water,
wherein components a) to f) add up to 100% by weight.
